(19) United States
(12) Patent Application Publication
(10) Pub. No.: US 2022/0382462 A1
(43) Pub. Date: Dec. 1, 2022

(54) INFORMATION PROCESSING APPARATUS, INFORMATION PROCESSING METHOD, AND INFORMATION PROCESSING PROGRAM

(71) Applicant: FUJIFILM CORPORATION, Tokyo (JP)

(72) Inventors: Michitaka KONDO, Tokyo (JP); Yutaka OISHI, Tokyo (JP); Takashi MIYAMOTO, Tokyo (JP); Terue WATANABE, Tokyo (JP); Koji MATSUMURA, Tokyo (JP); Yuko UNO, Tokyo (JP)

(21) Appl. No.: 17/818,716

(22) Filed: Aug. 10, 2022

Related U.S. Application Data
(63) Continuation of application No. PCT/JP2021/000906, filed on Jan. 13, 2021.

(30) Foreign Application Priority Data
Feb. 28, 2020 (JP) 2020-034303

(51) Int. Cl. G06F 3/06

(52) U.S. Cl. CPC G06F 3/0614; G06F 3/0667; G06F 3/0682

(57) ABSTRACT

An information processing apparatus acquires a plurality of pieces of data having any one of a plurality of different attribute values, and performs control of recording the plurality of pieces of data in a magnetic tape in a contiguous sequence of pieces of data having one of different attribute values or data groups having different attribute values.

### CROSS-REFERENCE TO RELATED APPLICATIONS

This application is a continuation application of International Application No. PCT/JP2021/000906, filed Jan. 13, 2021, the disclosure of which is incorporated herein by reference in its entirety. Further, this application claims priority from Japanese Patent Application No. 2020-034303, filed on Feb. 28, 2020, the disclosure of which is incorporated herein by reference in its entirety.

### BACKGROUND

### 1. Technical Field

The present disclosure relates to an information processing apparatus, an information processing method, and an information processing program.

### 2. Description of the Related Art

In order to shorten a reading time of data from a magnetic tape, a technique for recording a plurality of pieces of data in a magnetic tape in descending order of access frequency is disclosed (refer to JP1999-31376A (JP-H11-31376A) and JP2010-152603A).

### SUMMARY

In the techniques described in JP1999-31376A (JP-H11-31376A) and JP2010-152603A, for example, in a case where a reading instruction for different data recorded in a magnetic tape is input at the same time from a plurality of systems, a certain system may just wait for data arrival. In this case, parallel processing using a plurality of pieces of data recorded in the magnetic tape cannot be efficiently performed.

The present disclosure has been made in view of the above circumstances, and an object of the present disclosure is to provide an information processing apparatus, an information processing method, and an information processing program capable of efficiently performing parallel processing using a plurality of pieces of data recorded in a magnetic tape.

According to an aspect of the present disclosure, there is provided an information processing apparatus including: at least one processor, in which the processor is configured to acquire a plurality of pieces of data having any one of a plurality of different attribute values, and perform control of recording the plurality of pieces of data in a magnetic tape in a contiguous sequence of pieces of data having one of different attribute values or data groups having different attribute values.

In the information processing apparatus according to the aspect of the present disclosure, the processor may be configured to, in a case where one piece of the data has a plurality of types of attributes, perform the control for a plurality of magnetic tapes for each of different attributes.

Further, in the information processing apparatus according to the aspect of the present disclosure, the processor may be configured to perform the control for the data of which a size is equal to or smaller than a predetermined threshold value.

Further, in the information processing apparatus according to the aspect of the present disclosure, the processor may be configured to further perform control of recording the plurality of pieces of data in the magnetic tape such that a recording density of pieces of data having each attribute value in a local region of the magnetic tape is equal to or higher than a predetermined threshold value.

Further, in the information processing apparatus according to the aspect of the present disclosure, the processor may be configured to further perform, in a case of adding, to the magnetic tape, a plurality of pieces of data including data having an attribute value different from an attribute value of data recorded in the magnetic tape by performing the control, control of recording the data having the different attribute value from a head of the magnetic tape in a longitudinal direction.

Further, according to another aspect of the present disclosure, there is provided an information processing method executed by a processor of an information processing apparatus, the method including: acquiring a plurality of pieces of data having any one of a plurality of different attribute values; and performing control of recording the plurality of pieces of data in a magnetic tape in a contiguous sequence of pieces of data having one of different attribute values or data groups having different attribute values.

Further, according to another aspect of the present disclosure, there is provided an information processing program causing a processor of an information processing apparatus to execute a process including: acquiring a plurality of pieces of data having any one of a plurality of different attribute values; and performing control of recording the plurality of pieces of data in a magnetic tape in a contiguous sequence of pieces of data having one of different attribute values or data groups having different attribute values.

According to the present disclosure, it is possible to efficiently perform parallel processing using a plurality of pieces of data recorded in a magnetic tape.

### BRIEF DESCRIPTION OF THE DRAWINGS

FIG. 1 is a block diagram illustrating an example of a configuration of a recording and reproducing system.

FIG. 2 is a diagram for explaining an object.

FIG. 3 is a block diagram illustrating an example of a hardware configuration of an information processing apparatus.

FIG. 4 is a block diagram illustrating an example of a functional configuration of the information processing apparatus.

FIG. 5 is a diagram illustrating an example of a recording order of data to a magnetic tape according to an embodiment.

FIG. 6 is a diagram illustrating an example of a recording order of data to a magnetic tape according to a modification example.

FIG. 7 is a flowchart illustrating an example of object recording processing.

FIG. 8 is a diagram for explaining object reading processing according to the embodiment.

FIG. 9 is a diagram illustrating an example of a recording order of data to a magnetic tape according to a comparative example.

FIG. 10 is a diagram for explaining object reading processing according to the comparative example.

FIG. 11 is a diagram illustrating an example of a recording order of data to a magnetic tape according to a modification example.

FIG. 12 is a diagram illustrating an example of a recording order of data to a magnetic tape according to a modification example.

FIG. 13 is a diagram for explaining a recording density of data.

FIG. 14 is a diagram illustrating an example of a recording order of data to a magnetic tape according to a modification example.

### DETAILED DESCRIPTION

Hereinafter, an example of an embodiment for performing a technique according to the present disclosure will be described in detail with reference to the drawings.

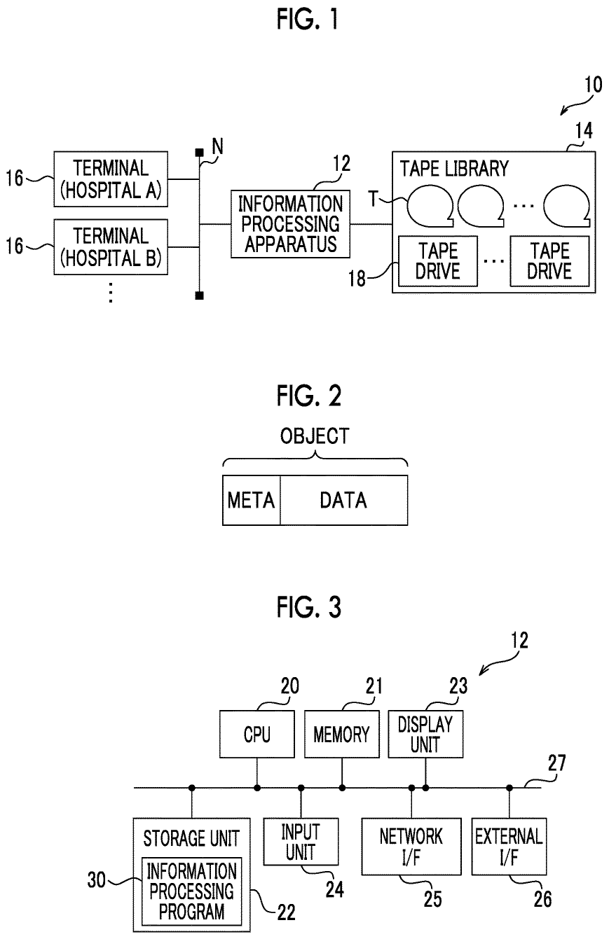

First, a configuration of a recording and reproducing system 10 according to the present embodiment will be described with reference to FIG. 1. As illustrated in FIG. 1, the recording and reproducing system 10 includes an information processing apparatus 12 and a tape library 14. Further, the information processing apparatus 12 and a plurality of terminals 16 are connected to a network N, and can perform communication with each other via the network N. In the present embodiment, an example of an embodiment in which a system for managing medical data is applied as a recording and reproducing system 10 will be described.

The tape library 14 includes a plurality of slots (not illustrated) and a plurality of tape drives 18, and each slot includes a magnetic tape T as an example of a recording medium. Each tape drive 18 is connected to the information processing apparatus 12. Examples of the magnetic tape T include a linear tape-open (LTO) tape.

In a case where the information processing apparatus 12 writes or reads data to or from the magnetic tape T, the magnetic tape T as a write target or a read target is loaded from the slot into a predetermined tape drive 18. In a case where data is written or read to and from the magnetic tape T loaded into the tape drive 18, the magnetic tape T is unloaded from the tape drive 18 into the slot in which the magnetic tape T is originally included.

In the present embodiment, as an example, as illustrated in FIG. 2, as a unit for handling data to be recorded in the magnetic tape T, an example of an embodiment in which an object including data to be saved by a user such as document data and image data and metadata related to the data is applied will be described. In the example of FIG. 2, the metadata is referred to as “meta”. A storage system that handles the object is called an object storage system. Further, in the present embodiment, an example of an embodiment in which medical data according to a predetermined standard such as digital imaging and communications in medicine (DICOM) is applied as data to be recorded in the magnetic tape T will be described. The metadata includes, for example, object identification information such as an object identifier (ID), data identification information such as a data name, a size of data, and attribute information such as a time stamp. The recording order of the data and the metadata when recording the object in the magnetic tape T is not particularly limited, and may be an order of the metadata and the data or an order of the data and the metadata.

The plurality of terminals 16 are respectively provided in a plurality of different hospitals. In the object transmitted from the terminal 16 to the information processing apparatus 12, an attribute value such as “hospital A” and “hospital B” is added to an attribute “hospital name” as an example of identification information of the hospital in which the terminal 16 is provided.

Next, a hardware configuration of the information processing apparatus 12 according to the present embodiment will be described with reference to FIG. 3. As illustrated in FIG. 3, the information processing apparatus 12 includes a central processing unit (CPU) 20, a memory 21 as a temporary memory area, and a non-volatile storage unit 22. Further, the information processing apparatus 12 includes a display unit 23 such as a liquid crystal display, an input unit 24 such as a keyboard and a mouse, a network interface (I/F) 25 connected to the network N, and an external I/F 26 to which the tape drive 18 is connected. The CPU 20, the memory 21, the storage unit 22, the display unit 23, the input unit 24, the network I/F 25, and the external I/F 26 are connected to a bus 27.

The storage unit 22 is realized by a hard disk drive (HDD), a solid state drive (SSD), a flash memory, or the like. An information processing program 30 is stored in the storage unit 22 as a storage medium. The CPU 20 reads the information processing program 30 from the storage unit 22, develops the read information processing program 30 in the memory 21, and executes the developed information processing program 30. Examples of the information processing apparatus 12 include a server computer and the like.

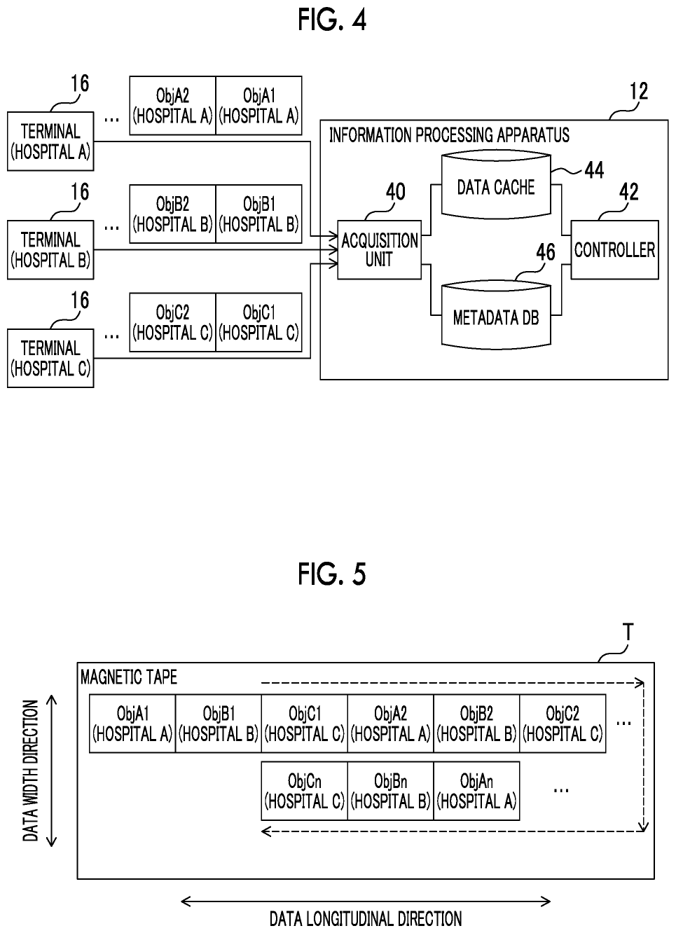

Next, a functional configuration in a case of recording the object in the magnetic tape T of the information processing apparatus 12 according to the present embodiment will be described with reference to FIG. 4. As illustrated in FIG. 4, the information processing apparatus 12 includes an acquisition unit 40 and a controller 42. In a case where the CPU 20 executes the information processing program 30, the information processing apparatus 12 functions as the acquisition unit 40 and the controller 42. Further, in a predetermined storage area of the storage unit 22, a data cache 44 for storing the data and a metadata database (DB) 46 for storing the metadata are prepared.

The acquisition unit 40 acquires the data transmitted from each terminal 16 and the metadata related to the data by using an application programming interface (API) for handling the object via the network I/F 25. As described above, in the present embodiment, a name of a hospital in which each terminal 16 is provided is added as an attribute value to the object transmitted from each terminal 16. That is, the acquisition unit 40 acquires a plurality of objects having any one of a plurality of different attribute values. In the example of FIG. 4, the attribute value added to the object is indicated in parentheses. Further, in the example of FIG. 4, three examples of the attribute values of “hospital A”, “hospital B”, and “hospital C” are indicated. The acquisition unit 40 stores data included in the acquired object in the data cache 44, and stores metadata included in the object in the metadata DB 46.

The controller 42 performs control of recording a plurality of objects each of which includes each of a plurality of pieces of data and each of a plurality of pieces of corresponding metadata which are stored in the data cache 44 and the metadata DB 46, in the magnetic tape T in a contiguous sequence of objects having one of different attribute values. Specifically, as an example, as illustrated in FIG. 5, the controller 42 performs control of recording objects in the magnetic tape T in order of an object of which an attribute value “hospital name” is “hospital A”, an object of which an attribute value “hospital name” is “hospital B”, and an object of which an attribute value “hospital name” is “hospital C”. In the example of FIG. 5, the attribute value added to the object is indicated in parentheses. Further, a broken line arrow in FIG. 5 indicates a relative movement direction of a magnetic head with respect to the magnetic tape T.

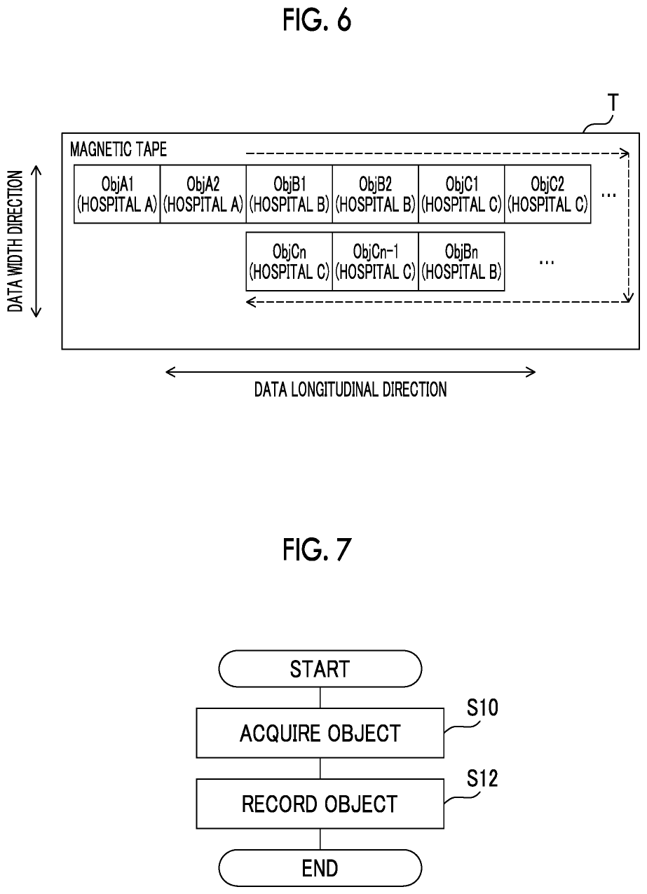

As illustrated in FIG. 6, the controller 42 may perform control of recording the plurality of objects in the magnetic tape T in a contiguous sequence of object groups having different attribute values. FIG. 6 illustrates an example in which object groups including two objects having the same attribute value are recorded in the magnetic tape T in a contiguous sequence of object groups having different attribute values. In this case, preferably, a total size of each object group is equal to or smaller than a predetermined threshold value according to a data processing speed of each terminal 16, a data transmission speed to each terminal 16, and the like.

Next, an operation of the information processing apparatus 12 according to the present embodiment will be described with reference to FIG. 7. In a case where the CPU 20 executes the information processing program 30, object recording processing illustrated in FIG. 7 is executed. The object recording processing illustrated in FIG. 7 is executed, for example, in a case where an execution instruction is input by the user via the input unit 24.

In step S10 of FIG. 7, the acquisition unit 40 acquires an object transmitted from each terminal 16 as described above. The acquisition unit 40 stores data included in the acquired object in the data cache 44, and stores metadata included in the object in the metadata DB 46.

In step S12, as described above, the controller 42 performs control of recording a plurality of objects each of which includes each of a plurality of pieces of data and each of a plurality of pieces of corresponding metadata which are stored in the data cache 44 and the metadata DB 46, in the magnetic tape T in a contiguous sequence of objects having one of different attribute values. In a case where processing of step S12 is completed, object recording processing is completed.

Processing of reading objects from the magnetic tape T in which the objects are recorded in the above-described recording order will be described. Here, as an example, a case where a reading instruction of objects having different attribute values is input to the information processing apparatus 12 from the plurality of terminals 16 will be described. Specifically, a case where a reading instruction of an object having an attribute value “hospital A” is input to the information processing apparatus 12 from a terminal 16 provided in “hospital A”, a reading instruction of an object having an attribute value “hospital B” is input to the information processing apparatus 12 from a terminal 16 provided in “hospital B”, and a reading instruction of an object having an attribute value “hospital C” is input to the information processing apparatus 12 from a terminal 16 provided in “hospital C” will be described.

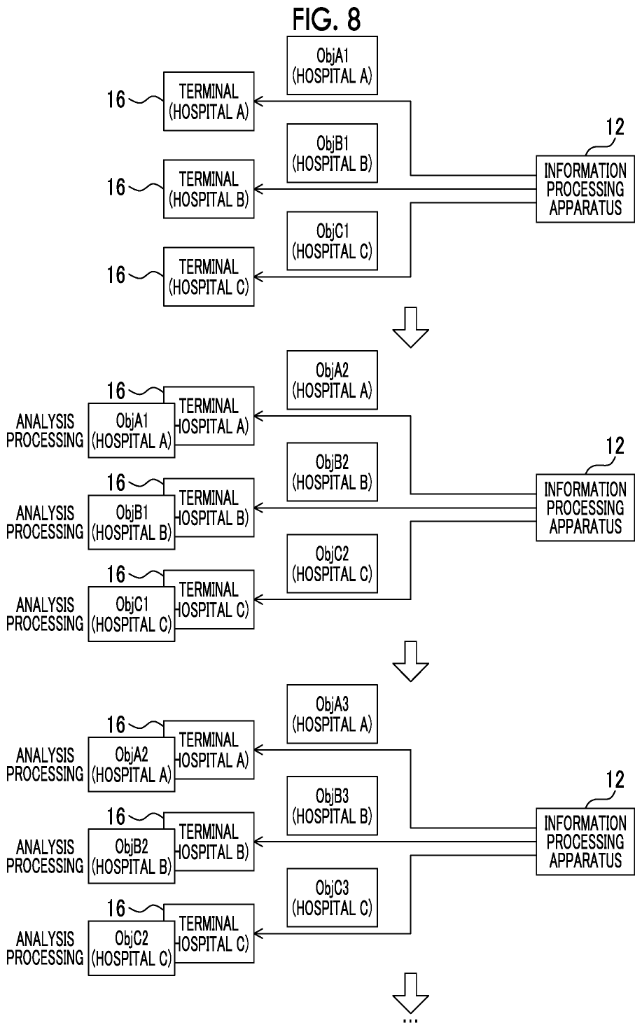

In this case, the controller 42 performs control of reading the objects from the magnetic tape T in which the objects are recorded. The tape drive 18 sequentially outputs the objects which are sequentially read from the magnetic tape T to the information processing apparatus 12. As illustrated in FIG. 8, the controller 42 transmits the object read from the magnetic tape T to the terminal 16 provided in the hospital corresponding to the attribute value, based on the attribute value “hospital name” of the object, via the network I/F 25. In FIG. 8, an example in which the information processing apparatus 12 transmits the read objects to the terminal 16 provided in each hospital in order of hospital A, hospital B, and hospital C according to the recording order of the objects in the magnetic tape T. Therefore, as illustrated in FIG. 8, the terminal 16 provided in each hospital can perform analysis processing using the previously received object until the next object is received.

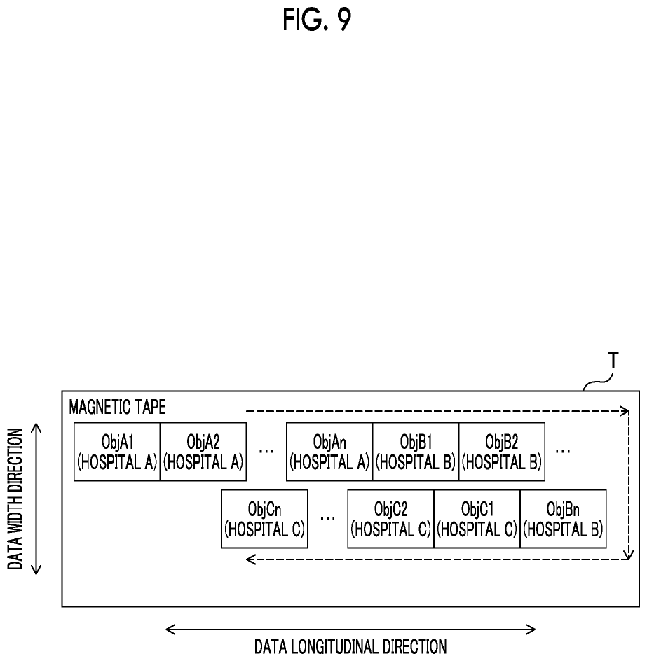

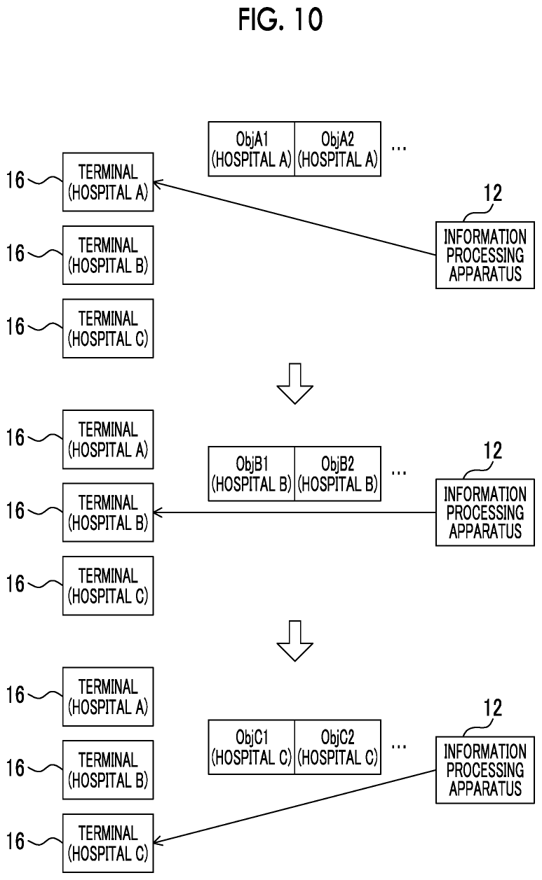

On the other hand, as an example, as illustrated in FIG. 9, a case where a plurality of objects are recorded in the magnetic tape T for each group of the same attribute value is considered. In this case, as illustrated in FIG. 10, all objects having an attribute value “hospital A” are read from the magnetic tape T, and the read objects are transmitted to the terminal 16 provided in “hospital A”. Then, the terminal 16 provided in “hospital B” receives objects having an attribute value “hospital B”. Similarly, all objects having an attribute value “hospital A” and all objects having an attribute value “hospital B” are read from the magnetic tape T, and the read objects are transmitted to the terminals 16 provided in each of “hospital A” and “hospital B”. Then, the terminal 16 provided in “hospital C” receives objects having an attribute value “hospital C”. For this reason, in the terminals 16 provided in “hospital B” and “hospital C”, a waiting time for receiving the objects read from the magnetic tape T after an object reading instruction is output to the information processing apparatus 12 becomes long.

In the present embodiment, objects are recorded in the magnetic tape T in a contiguous sequence of objects having one of different attribute values. Therefore, in the present embodiment, the terminal 16 provided in each hospital can perform analysis processing using the previously received object until the next object is received. For this reason, in the present embodiment, a waiting time for receiving the objects can be shortened as compared with the example described with reference to FIG. 9 and FIG. 10. Thereby, it is possible to efficiently perform parallel processing using a plurality of pieces of data recorded in the magnetic tape T.

In the embodiment, in a case where one object has a plurality of types of attributes, the controller 42 may perform control of recording objects in each of a plurality of magnetic tapes Ts for each of different attributes in the recording order according to the embodiment. As a specific example, a case where one object has two types of attributes “hospital name” and “date” will be described.

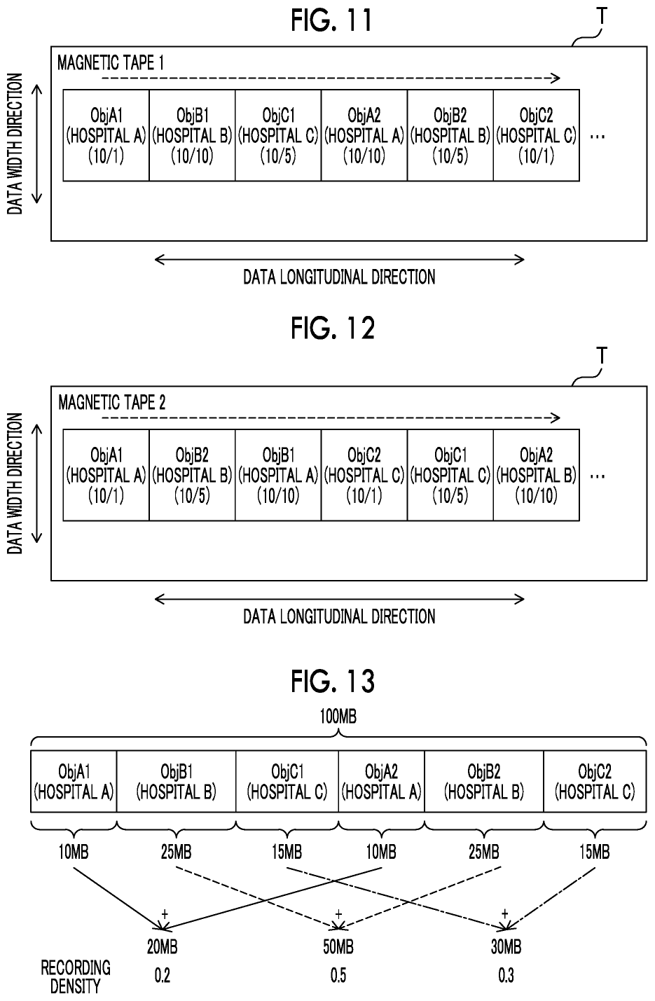

In this case, as illustrated in FIG. 11, the controller 42 performs control of recording, for an attribute “hospital name”, objects in a first magnetic tape T in a contiguous sequence of objects having one of different attribute values. Further, in this case, as illustrated in FIG. 12, the controller 42 performs control of recording, for an attribute “date”, objects in a second magnetic tape T in a contiguous sequence of objects having one of different attribute values. In the objects illustrated in FIG. 11 and FIG. 12, a notation in upper parentheses indicates the attribute value “hospital name” of the object, and a notation in lower parentheses indicates the attribute value “date” of the object. Further, broken line arrows in FIG. 11 and FIG. 12 indicate the same meaning as the meaning in FIG. 5.

In the example of the embodiment, in a case where a reading instruction of objects having attribute values different from the attribute value “hospital name” is input, the information processing apparatus 12 performs control of reading objects from the first magnetic tape T. Further, in a case where a reading instruction of objects having attribute values different from the attribute value “date” is input, the information processing apparatus 12 performs control of reading objects from the second magnetic tape T. Thereby, it is possible to efficiently perform parallel processing using a plurality of pieces of data recorded in the magnetic tape T according to the attribute.

Further, in the embodiment, the controller 42 may perform control of recording objects of which the sizes are equal to or smaller than a predetermined threshold value in the magnetic tape T in the recording order according to the embodiment. In this case, the controller 42 may perform control of recording objects of which the sizes exceed the threshold value in a magnetic tape T different from the magnetic tape T in which the objects having sizes equal to or smaller than the threshold value are recorded. The recording order of the objects having sizes exceeding the threshold value in the magnetic tape T is not particularly limited. For example, the recording order may be an order of arrival at the information processing apparatus 12.

Further, in the embodiment, the controller 42 may further perform control of recording a plurality of objects in the magnetic tape T such that a recording density of the objects having each attribute value in a local region of the magnetic tape T is equal to or higher than a predetermined threshold value. The local region means a partial region corresponding to a predetermined size (for example, 100 MB) in the magnetic tape T. Further, the recording density means a ratio of the objects having each attribute value in the local region. For example, as illustrated in FIG. 13, in a case where total 20 MB objects having the attribute value “hospital A” are recorded, total 50 MB objects having the attribute value “hospital B” are recorded, and total 30 MB objects having the attribute value “hospital C” are recorded in the local region corresponding to 100 MB in the magnetic tape T, the recording density is as follows. In this case, the recording density of the objects having the attribute value “hospital A” is 0.2 (=20±100), the recording density of the objects having the attribute value “hospital B” is 0.5 (=50±100), and the recording density of the objects having the attribute value “hospital C” is 0.3 (=30±100).

Further, in the example of the embodiment, the threshold value may have the same value or different values for the objects having each attribute value. Further, in the example of the embodiment, in a case where the threshold value has different values, the threshold value may have different values depending on a difference in data processing speed of the terminal 16 as an object transmission destination, a difference in data transmission speed to the terminal 16 as an object transmission destination, and the like. Further, in the example of the embodiment, the total value of each threshold value may be 1 or smaller than 1.

Further, in the embodiment, in a case of adding, to the magnetic tape T, a plurality of pieces of data including data having an attribute value different from an attribute value of data recorded in the magnetic tape T by performing the control, the controller 42 further performs control of recording the data having the different attribute value from a head of the magnetic tape T in a longitudinal direction. The head of the magnetic tape T in the longitudinal direction represents a portion that can be first accessed when the magnetic tape T is unloaded from the magnetic tape cartridge, and is sometimes referred to as the beginning of tape (BOT).

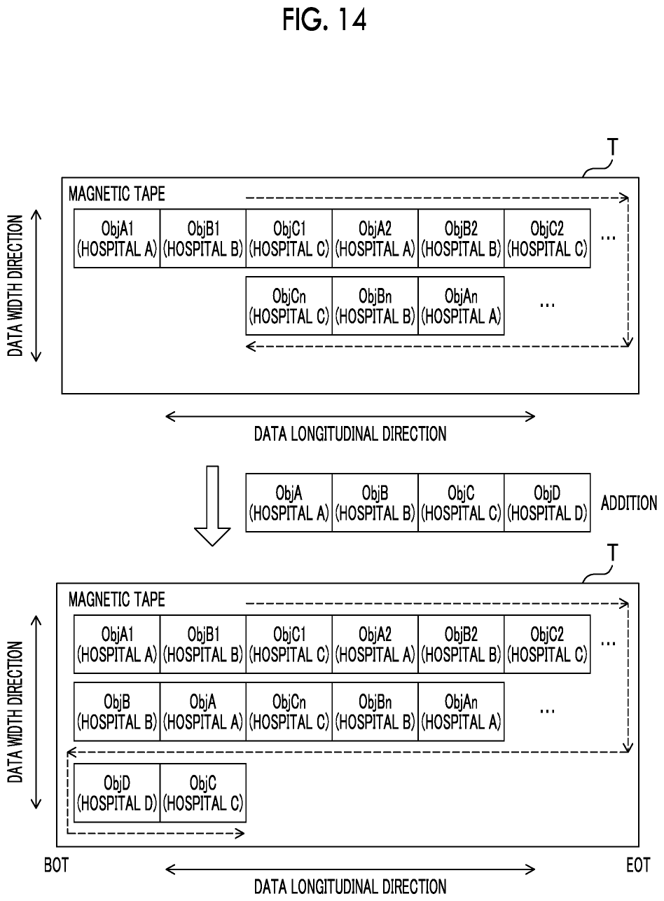

Specifically, as illustrated in an upper part of FIG. 14, in a state where a plurality of objects having any one of the attribute values “hospital A” to “hospital C” are recorded in the magnetic tape T in order of “hospital A” to “hospital C”, a case where a plurality of objects to be described below are added will be described as an example. In the example, from the above state, an object having an attribute value “hospital D” is added, and a plurality of objects having any one of the attribute values “hospital A” to “hospital D” are added to the magnetic tape T.

As illustrated in a lower part of FIG. 14, in this case, as in the embodiment, the controller 42 performs control of recording a plurality of objects in the magnetic tape T in a contiguous sequence of pieces of data having one of different attribute values. Further, in this case, the controller 42 performs control of recording the newly-added object having the attribute value “hospital D” from the head of the magnetic tape T in the longitudinal direction. Thereby, in a case where a reading instruction of the object having the attribute value “hospital D” is input to the information processing apparatus 12, it is possible to immediately read the object having the attribute value “hospital D”. A notation in parentheses and a broken line arrow in FIG. 14 are the same as those in FIG. 5.

Further, in the embodiment, a case where the technique according to the present disclosure is applied to an object storage system has been described. On the other hand, the present disclosure is not limited thereto. The technique according to the present disclosure may be applied to a file storage system that handles data in file units.

Further, in the embodiment, for example, as a hardware structure of a processing unit that executes various processing such as the acquisition unit 40 and the controller 42, the following various processors may be used. The various processors include, as described above, a CPU which is a general-purpose processor that functions as various processing units by executing software (program), and a dedicated electric circuit which is a processor having a circuit configuration specifically designed to execute specific processing, such as a programmable logic device (PLD) or an application specific integrated circuit (ASIC) that is a processor of which the circuit configuration may be changed after manufacturing such as a field programmable gate array (FPGA).

One processing unit may be configured by one of these various processors, or may be configured by a combination of two or more processors of the same type or different types (for example, a combination of a plurality of FPGAs or a combination of a CPU and an FPGA). Further, the plurality of processing units may be configured by one processor.

As an example in which the plurality of processing units are configured by one processor, firstly, as represented by a computer such as a client and a server, a form in which one processor is configured by a combination of one or more CPUs and software and the processor functions as the plurality of processing units may be adopted. Secondly, as represented by a system on chip (SoC) or the like, a form in which a processor that realizes the function of the entire system including the plurality of processing units by one integrated circuit (IC) chip is used may be adopted. As described above, the various processing units are configured by using one or more various processors as a hardware structure.

Further, as the hardware structure of the various processors, more specifically, an electric circuit (circuitry) in which circuit elements such as semiconductor elements are combined may be used.

Further, in the embodiment, an example in which the information processing program 30 is stored (installed) in the storage unit 22 in advance has been described. On the other hand, the present disclosure is not limited thereto. The information processing program 30 may be provided by being recorded in a recording medium such as a compact disc read only memory (CD-ROM), a digital versatile disc read only memory (DVD-ROM), or a Universal Serial Bus (USB) memory. Further, the information processing program 30 may be downloaded from an external apparatus via a network.

In the disclosure of Japanese Patent Application No. 2020-034303, filed Feb. 28, 2020, the entire contents of which are incorporated herein by reference. Further, all documents, patent applications, and technical standards mentioned in this specification are incorporated herein by reference to the same extent as in a case where each document, each patent application, and each technical standard are specifically and individually described by being incorporated by reference.

What is claimed is:

1. An information processing apparatus comprising:
at least one processor,
wherein the processor is configured to
acquire a plurality of pieces of data having any one of a plurality of different attribute values, and
perform control of recording the plurality of pieces of data in a magnetic tape in a contiguous sequence of pieces of data having one of different attribute values or data groups having different attribute values.

2. The information processing apparatus according to claim 1,
wherein the processor is configured to, in a case where one piece of the data has a plurality of types of attributes, perform the control for a plurality of magnetic tapes for each of different attributes.

3. The information processing apparatus according to claim 1,
wherein the processor is configured to perform the control for the data of which a size is equal to or smaller than a predetermined threshold value.

4. The information processing apparatus according to claim 1,
wherein the processor is configured to further perform control of recording the plurality of pieces of data in the magnetic tape such that a recording density of pieces of data having each attribute value in a local region of the magnetic tape is equal to or higher than a predetermined threshold value.

5. The information processing apparatus according to claim 1,
wherein the processor is configured to further perform, in a case of adding, to the magnetic tape, a plurality of pieces of data including data having an attribute value different from an attribute value of data recorded in the magnetic tape by performing the control, control of recording the data having the different attribute value from a head of the magnetic tape in a longitudinal direction.

6. The information processing apparatus according to claim 2,
wherein the processor is configured to perform the control for the data of which a size is equal to or smaller than a predetermined threshold value.

7. The information processing apparatus according to claim 2,
wherein the processor is configured to further perform control of recording the plurality of pieces of data in the magnetic tape such that a recording density of pieces of data having each attribute value in a local region of the magnetic tape is equal to or higher than a predetermined threshold value.

8. The information processing apparatus according to claim 3,
wherein the processor is configured to further perform control of recording the plurality of pieces of data in the magnetic tape such that a recording density of pieces of data having each attribute value in a local region of the magnetic tape is equal to or higher than a predetermined threshold value.

9. The information processing apparatus according to claim 6,
wherein the processor is configured to further perform control of recording the plurality of pieces of data in the magnetic tape such that a recording density of pieces of data having each attribute value in a local region of the magnetic tape is equal to or higher than a predetermined threshold value.

10. The information processing apparatus according to claim 2,
wherein the processor is configured to further perform, in a case of adding, to the magnetic tape, a plurality of pieces of data including data having an attribute value different from an attribute value of data recorded in the magnetic tape by performing the control, control of recording the data having the different attribute value from a head of the magnetic tape in a longitudinal direction.

11. The information processing apparatus according to claim 3,
wherein the processor is configured to further perform, in a case of adding, to the magnetic tape, a plurality of pieces of data including data having an attribute value different from an attribute value of data recorded in the magnetic tape by performing the control, control of recording the data having the different attribute value from a head of the magnetic tape in a longitudinal direction.

12. The information processing apparatus according to claim 4,
wherein the processor is configured to further perform, in a case of adding, to the magnetic tape, a plurality of pieces of data including data having an attribute value different from an attribute value of data recorded in the magnetic tape by performing the control, control of recording the data having the different attribute value from a head of the magnetic tape in a longitudinal direction.

13. The information processing apparatus according to claim 6,
wherein the processor is configured to further perform, in a case of adding, to the magnetic tape, a plurality of pieces of data including data having an attribute value different from an attribute value of data recorded in the magnetic tape by performing the control, control of recording the data having the different attribute value from a head of the magnetic tape in a longitudinal direction.

14. The information processing apparatus according to claim 7,
wherein the processor is configured to further perform, in a case of adding, to the magnetic tape, a plurality of pieces of data including data having an attribute value different from an attribute value of data recorded in the magnetic tape by performing the control, control of recording the data having the different attribute value from a head of the magnetic tape in a longitudinal direction.

15. The information processing apparatus according to claim 8,
wherein the processor is configured to further perform, in a case of adding, to the magnetic tape, a plurality of pieces of data including data having an attribute value different from an attribute value of data recorded in the magnetic tape by performing the control, control of recording the data having the different attribute value from a head of the magnetic tape in a longitudinal direction.

16. The information processing apparatus according to claim 9,
wherein the processor is configured to further perform, in a case of adding, to the magnetic tape, a plurality of pieces of data including data having an attribute value different from an attribute value of data recorded in the magnetic tape by performing the control, control of recording the data having the different attribute value from a head of the magnetic tape in a longitudinal direction.

17. An information processing method executed by a processor of an information processing apparatus, the method comprising:
acquiring a plurality of pieces of data having any one of a plurality of different attribute values; and
performing control of recording the plurality of pieces of data in a magnetic tape in a contiguous sequence of pieces of data having one of different attribute values or data groups having different attribute values.

18. A non-transitory computer-readable storage medium storing an information processing program causing a processor of an information processing apparatus to execute a process comprising:
acquiring a plurality of pieces of data having any one of a plurality of different attribute values; and
performing control of recording the plurality of pieces of data in a magnetic tape in a contiguous sequence of pieces of data having one of different attribute values or data groups having different attribute values.
